(19) United States
(12) Patent Application Publication
(10) Pub. No.: US 2002/0101534 A1
(43) Pub. Date: Aug. 1, 2002

(54) Expansion apparatus for digital camera

(76) Inventor: Andrew Liu, Taipei (TW)

Correspondence Address: BIRCH STEWART KOLASCH & BIRCH, PO BOX 747, FALLS CHURCH, VA, 22040-0747, US

(21) Appl. No.: 09/893,881

(22) Filed: Jun. 29, 2001

(30) Foreign Application Priority Data
Dec. 30, 2000 (TW) 89222844

(51) Int. Cl. H04N 5/225; H04N 7/14

(52) U.S. Cl. 348/375; 348/376; 348/14.02; 348/14.04

(57) ABSTRACT

An expansion apparatus for digital camera includes a housing, output terminals located outside the housing and an input terminal. The input terminal is located in the housing for engaging with an output terminal of the digital camera and links to the output terminals and a transmission cable which transmit images to an output device for subsequent process. When there is a desire for image transmission, just place the digital camera into the housing to connect with the input terminal is all the action needed. There is no more wiring or plugging of the transmission cables to the output terminals of the digital camera. It thus greatly enhances the convenience of using the digital camera.

### FIELD OF THE INVENTION

This invention relates to an expansion apparatus for digital camera.

### BACKGROUND OF THE INVENTION

Among the many means presently available for people to capture the memorable time and occasions, photo is the most widely used one. During travel, meeting, or any other events where people want to get something to remember by, camera (conventional camera or digital camera) always is one of the most preferred choices to capture and record the moment for later viewing and enjoying. Digital camera, because of its great versatility and decreasing price, has had growing popularity in recent years.

Digital camera is very convenient to perform a lot function not possible for conventional film cameras. However when users capture the images and want to transmit the images, they have to connect various types of connector to the terminal sockets located on the digital camera (such as to connect a cable to a modem, or connect a cable to a computer, or a LAN or Internet or the like) for transmitting the stored images to an output device desired. It becomes a source of confusion and an annoyance to many users. There are still rooms for improvement.

### SUMMARY OF THE INVENTION

It is therefore an object of this invention to provide an expansion apparatus for digital camera for improving convenience in image transmission.

The expansion apparatus according to this invention includes a housing, output terminals located at outer side of the housing and an input terminal. The input terminal is located in the housing for engaging with an output terminal of the digital camera and links to the output terminals and a transmission cable which transmit images to an output device for subsequent process. When there is a desire for image transmission, just place the digital camera into the housing to connect with the input terminal is all the action needed. There is no more wiring or plugging of the transmission cables to the output terminals of the digital camera. It thus greatly enhances the convenience of using digital camera.

### BRIEF DESCRIPTION OF THE DRAWINGS

The invention, as well as its many advantages, may be further understood by the following detailed description and drawings, in which:

FIG. 1 is a perspective view of this invention, with the digital camera detached from the housing.

FIG. 2 is a perspective view of this invention, with the digital camera engaged in the housing.

FIG. 3 is a perspective view of another embodiment of the digital camera coupling with the housing.

FIG. 4 is a perspective view of another embodiment of the housing of this invention.

### DESCRIPTION OF THE PREFERRED EMBODIMENTS

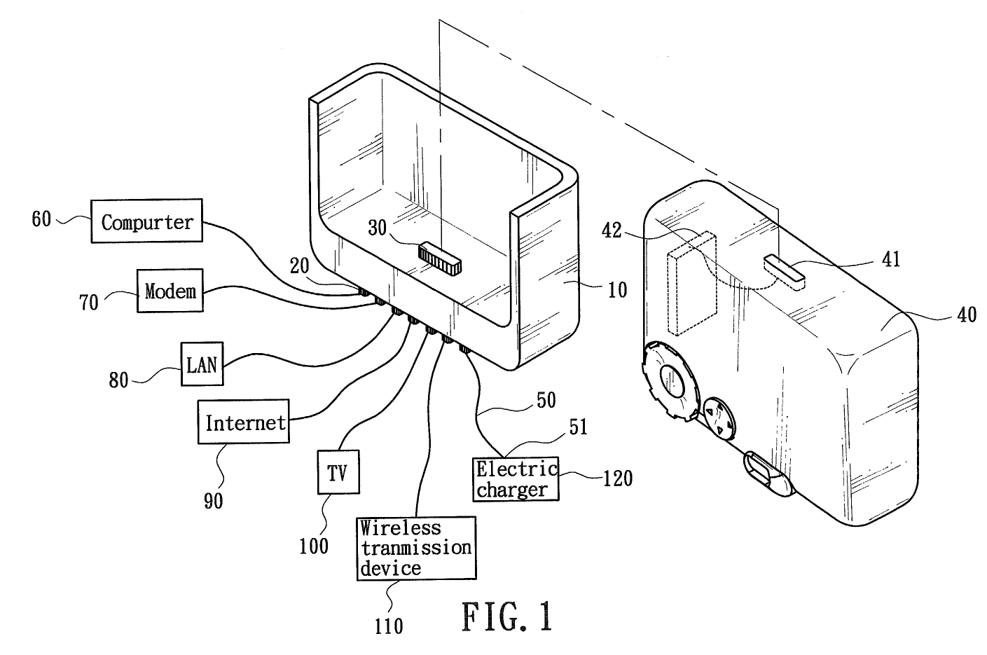

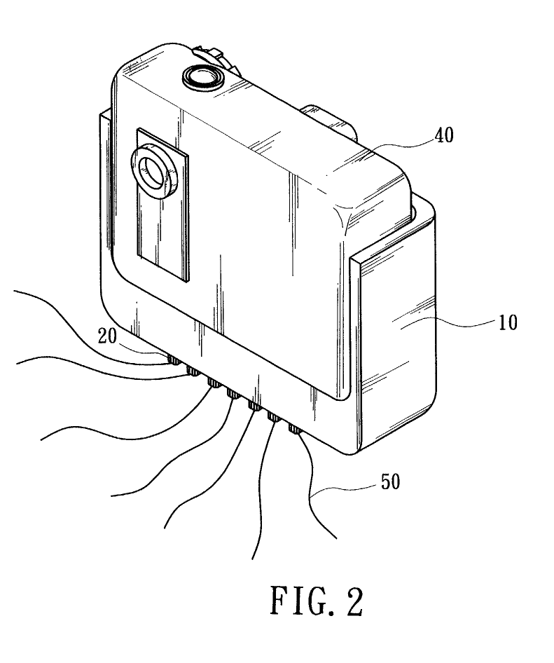

Referring to FIGS. 1 and 2, the expansion apparatus according to this invention includes a housing 10, output terminals 20 and an input terminal 30, and the mating output device for image transmission located in a digital camera 40 to perform subsequent image process.

The housing 10 is integrally formed and has substantially a L-shaped cross section with an interior space and dimension mating with the outside form and dimension of the digital camera 40 to enable the digital camera 40 housed therein.

The output terminals 20 have multiple number and are located at the outer surface of the housing 10 to connect electrically with a plurality of transmission cables 50. Each transmission cable 50 has one end engaged with a connector 51 and another also engaged with a connector 51 for linking to an output device (such as computer 60, modem 70, LAN 80, Internet 90, TV 100, Wireless transmission device 110, electric charger 120, or the like) to perform image transmission desired.

The input terminal 30 is located in the housing 10 to contact the digital camera 40 for receiving images from the digital camera to the housing 10.

The digital camera 40 has an output terminal 41 which electrically links to an image storage unit 42 of the digital camera 40 for transmitting images stored in the storage unit 42. When the digital camera 40 is housed in the housing 10 and the output terminal 41 connects electrically with the input terminal 30, the images stored in the image storage unit 42 may be transmitted through the output terminal 41, input terminal 30 to the output terminals 20 then through the transmission cable 50 to the output device desired for subsequent image process.

The electric charger 120 is separated from the digital camera 40 and located in the housing 10. This will help to make the size of digital camera 40 smaller and to further improve its portability. Furthermore, when the digital camera 40 is under electric charging, the heat generated won't affect the operation of the digital camera 40.

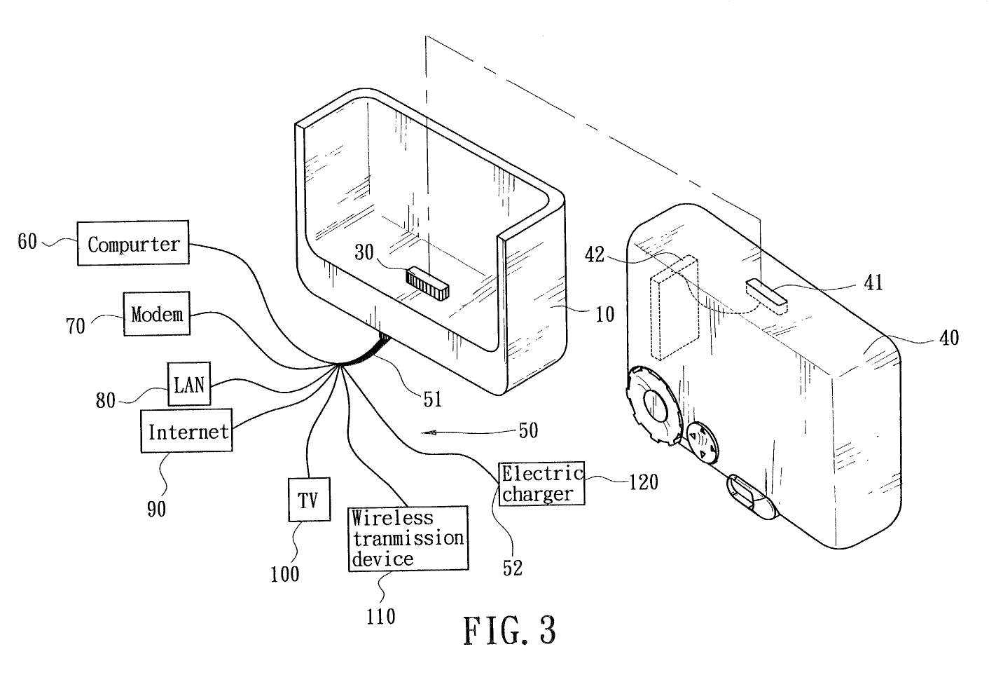

FIG. 3 shows another embodiment of this invention. It also includes a housing 10, an output terminal 20 and an input terminal 30, and the mating output device for image transmission located in a digital camera 40 to perform subsequent image process.

The housing 10 is integrally formed and has substantially a L-shaped cross section with an interior space and dimension mating with the outside form and dimension of the digital camera 40 to enable the digital camera 40 housed therein.

The output terminal 20 is located at the outer surface of the housing 10 to connect electrically with a transmission cable 50. The transmission cable 50 has one end converged to engage with a connector 51 and another end separated to engage with separated connectors 52 for linking various types of output devices (such as computer 60, modem 70, LAN 80, Internet 90, TV 100, Wireless transmission device 110, electric charger 120, or the like) to perform image transmission desired.

The input terminal 30 is located in the housing 10 to contact the digital camera 40 for receiving images from the digital camera to the housing 10.

The digital camera 40 has an output terminal 41 which electrically links to an image storage unit 42 of the digital camera 40 for transmitting images stored in the storage unit 42. When the digital camera 40 is housed in the housing 10 and the output terminal 41 connects electrically with the input terminal 30, the images stored in the image storage unit 42 may be transmitted through the output terminal 41, input terminal 30 to the output terminals 20 then through the transmission cable 50 to the output device desired for subsequent image process.

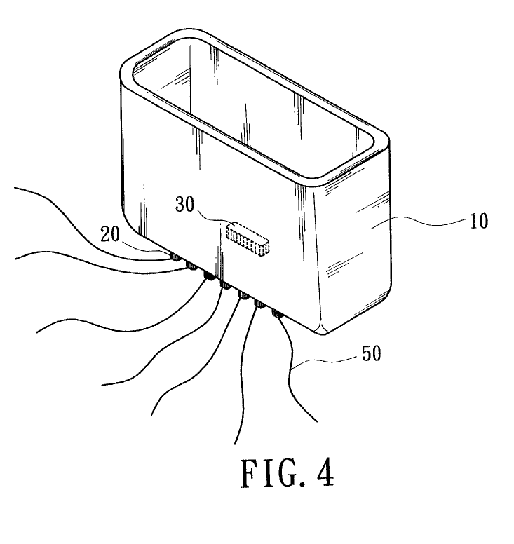

The form of the housing 10 may be made in a shape other than the L-shaped set forth above. FIG. 4 shows another embodiment of the housing 10 which is formed in a Ushaped for housing the digital camera 40 therein. The interior space and dimension of the housing 10 will also mate with the outside shape and dimension of the digital camera 40 to function as desired.

In summary, because this invention disposes the transmission cables on the housing, when using the digital camera to transmit images, there is no need to wiring or plugging the cables to or from the digital camera. Users only have to place the digital camera into the housing to make electrical connection with the input terminal, then images transmission may be preformed. As a result, it greatly improves the convenience and usability.

It may thus be seen that the objects of the present invention set forth herein, as well as those made apparent from the foregoing description, are efficiently attained. While the preferred embodiments of the invention have been set forth for purpose of disclosure, it would be obvious to those skilled in the art that various other changes and modifications can be made according to the embodiments. Accordingly, the appended claims are intended to cover all embodiments which do not depart from the spirit and scope of the invention.

What is claimed is:

1. An expansion apparatus for a digital camera, comprising:
a housing having an interior housing space formed in a shape and dimensions to mate with outside shape and dimension of the digital camera to house the digital camera therein;
an input terminal located in the housing to contact the digital camera for engaging with an output terminal of the digital camera for the digital camera to output stored images; and
at least one output terminal in the housing for connecting electrically with a transmission cable for output the images to an output device.

2. The expansion apparatus for a digital camera of claim 1, wherein the housing is formed in L shape.

3. The expansion apparatus for a digital camera of claim 1, wherein the housing is formed in U shape.

4. The expansion apparatus for a digital camera of claim 1, wherein the output device is a computer.

5. The expansion apparatus for a digital camera of claim 1, wherein the output device is a modem.

6. The expansion apparatus for a digital camera of claim 1, wherein the output device is a local area network.

7. The expansion apparatus for a digital camera of claim 1, wherein the output device is an Internet.

8. The expansion apparatus for a digital camera of claim 1, wherein the transmission cable has two ends each being a connector.

9. The expansion apparatus for a digital camera of claim 1, wherein the transmission cable has two ends, one end being a connector and another end being separated connectors.
